(19) United States
(12) Patent Application Publication
(10) Pub. No.: US 2026/0221699 A1
(43) Pub. Date: Jul. 30, 2026

(54) ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: SHIH-WEI HSIAO, New Taipei (TW); MING-LUN KUO, New Taipei (TW); JIA-HAU LIU, New Taipei (TW); HUNG-CHENG LIAO, New Taipei (TW); QIN-XIN CAO, Kunshan (CN); TSU-YANG WU, New Taipei (TW)

(21) Appl. No.: 19/459,331

(22) Filed: Jan. 26, 2026

(30) Foreign Application Priority Data
Jan. 24, 2025 (CN) 202510116259.0

(51) Int. Cl. H01R 13/6597; H01R 12/71; H01R 13/05

(52) U.S. Cl. CPC H01R 13/6597; H01R 12/71; H01R 13/05

(57) ABSTRACT

An electrical connector includes an insulating body, terminals, and a first grounding member. The insulating body has a slot passing through an upper face thereof. Each of the terminals includes a fixing portion embedded in the insulating body, a resilient portion extending upward from the fixing portion, a contact portion positioned at an end of the resilient portion and protruding into the slot, and a leg portion extending downward from the fixing portion out of a lower face of the insulating body. The terminals include signal terminal pairs and ground terminals positioned between neighboring signal terminal pairs. The first grounding members are arranged on an outer side of the terminals and each have a first shielding portion extending vertically and shielding outer sides of the signal terminal pairs and a grounding portion positioned outside the ground terminal and capable of contacting the corresponding ground terminal.

### BACKGROUND OF THE INVENTION

### Field of the Invention

The present invention relates to an electrical connector, particularly to an electrical connector having signal terminals, ground terminals, and a grounding member.

### Description of Related Arts

Electrical devices or equipment need to be connected and communicate through various connectors. For example, a computer and peripheral components need to be connected via connectors based on the Peripheral Component Interconnect-express (PCIe) protocol.

The current PCIe standard has reached the seventh generation or even higher, with higher bandwidth than previous generations. The unidirectional total transmission capacity can reach 28 Gbps, and the bidirectional transmission capacity can reach 512 GB/s. Due to the large number of channels, resonance may occur between different pairs of differential signal terminals in PCIe connectors, leading to interference between these pairs. To maintain the high-frequency transmission performance of PCIe, existing technologies typically address signal interference by improving the placement of the differential signal terminals between different pairs.

However, limited by channel configuration, the aforementioned existing techniques have not yet effectively reduced signal interference between different pairs of differential signal terminals.

### SUMMARY OF THE INVENTION

An electrical connector includes an elongated insulating body, a plurality of terminals, and a first grounding member. The insulating body has a slot passing through an upper face thereof and sidewalls on two sides of the slot. The terminals include a row of first terminals at one side of the slot and a row of second terminals at the other side of the slot. Each of the terminals includes a fixing portion embedded in the insulating body, a resilient portion extending upward from the fixing portion, a contact portion positioned at an end of the resilient portion and protruding into the slot, and a leg portion extending downward from the fixing portion out of a lower face of the insulating body. The first terminals include a plurality of first signal terminal pairs and first ground terminals positioned between neighboring first signal terminal pairs. The first grounding members are arranged on an outer side of the first terminals distal from the second terminals and each have a first shielding portion extending vertically and shielding outer sides of the first signal terminal pairs and a grounding portion positioned outside the first ground terminal and capable of contacting the corresponding first ground terminal. The first shielding portion extends upward beyond a height of the corresponding first signal terminal pair and protrudes outward near the contact portion to form an outward protrusion to provide space for the contact portion.

An electrical connector includes an insulator, a plurality of mating terminals, and a third grounding member. The insulator has a base and a tongue extending forward from the base. The mating terminals include a row of third terminals arranged on the lower side of the tongue and a row of fourth terminals arranged on the upper side of the tongue. The third terminals have a plurality of third signal terminal pairs and third ground terminals positioned between adjacent third signal terminal pairs. Each of the mating terminals has a fixing portion fixed in the base and a mating portion extending forward from the base and exposed on the side of the tongue, a first lower extension portion bent downward from the fixing portion, and a horizontal portion bent horizontally from the lower extension. The third grounding member is positioned between the third terminals and the fourth terminals and has second shielding portions shielding the third signal terminal pairs. Each of the second shielding portions has a second lower extension portion positioned on a first side of the first lower extension portion and facing the first lower extension portion to shield the first lower extension portion on one side.

### BRIEF DESCRIPTION OF DRAWINGS

FIG. 1 shows a perspective view of an electrical connector according to the present disclosure;

FIG. 2 shows an exploded view of a receptacle connector according to a first embodiment of the present disclosure;

FIG. 3 shows a perspective view of first terminals and a first grounding member of FIG. 2;

FIG. 4 shows a cross-sectional view of a receptacle connector;

FIG. 5 shows a perspective view of the first terminals and the first grounding member and a second ground member of FIG. 2;

FIG. 6 shows a perspective view of first terminals and a first grounding member .and a second grounding member according to s second embodiment of the present disclosure;

FIG. 7 shows a perspective view of the second grounding member of FIG. 6;

FIG. 8 shows a enlarged view of a portion of the first terminals of FIG. 6;

FIG. 9 shows cross-sectional view of a plug connector inserted into the a receptacle connector according to the second embodiment of the present disclosure;

FIG. 10 shows a perspective view of two rows of terminals and a first grounding member according to a third embodiment of the present disclosure;

FIG. 11 shows a cross-sectional view of first terminals and the first grounding member of FIG. 10;

FIG. 12 shows a perspective view of first terminals according to a fourth embodiment of the present disclosure;

FIG. 13 shows a perspective view of first ground terminals mating a plug connector of FIG. 12;

FIG. 14 shows an exploded view of a plug connector according to a fifth embodiment of the present disclosure;

FIG. 15 shows a perspective view of third terminals and a third grounding member of FIG. 14;

FIG. 16 shows a portion of a perspective view of the third terminals and a fourth grounding member of FIG. 14; and

FIG. 17 shows a portion of a perspective view of an insulating body having the third terminals and the third grounding member.

### DETAILED DESCRIPTION OF THE DRAWINGS

In the description of the embodiments of the present disclosure, the words “exemplary,” “or,” and “for example” are used to indicate examples, illustrations, or explanations. Any embodiment or design scheme described as “exemplary” or “for example” in the embodiments of the present disclosure should not be construed as being more preferred or advantageous than other embodiments or design schemes. Specifically, the use of the words “exemplary,” “or,” and “for example” is intended to present specific relevant concepts.

Unless otherwise defined, all technical and scientific terms used herein have the same meaning as commonly understood by one of ordinary skill in the art to which the present disclosure belongs. The terminology used in the specification of the present disclosure is for the purpose of describing particular embodiments only and is not intended to limit the application. It should be understood that, unless otherwise stated, “/” in the present disclosure means “or.” For example, A/B can mean A or B. “And/or” in the present disclosure is merely a description of the relationship between related objects, indicating that three relationships can exist. For example, A and/or B can represent: A alone, A and B simultaneously, or B alone. “At least one” means one or more. “More than one” means two or more. For example, at least one of a, b, or c can represent seven cases: a; b; c; a and b; a and c; b and c; and a, b, and c.

It should also be noted that the terms “first” and “second” in the specification, claims, and drawings of the present disclosure are used to distinguish similar objects, not to describe a specific order or sequence. The methods disclosed in the embodiments of the present disclosure, or the methods shown in the flowcharts, include one or more steps for implementing the method. Without departing from the scope of the claims, the execution order of steps can be interchanged, and some steps can be deleted.

Regarding different types of electrical devices or equipment, devices or equipment need to be connected and communicated through various connectors. For example, a computer and peripheral components need to be connected through a connector based on the Peripheral Component Interconnect-express (PCIe) protocol.

The current PCIe standard has reached the seventh generation or even higher, having bandwidth higher than those of previous generations. The unidirectional total transmission capacity can reach 28 Gbps, and the bidirectional transmission capacity can reach 512 GB/s. Due to the large number of channels, such as some PCIe-based connectors having up to 164 pins, resonance may occur between different pairs of differential signal terminals in PCIe connectors, leading to interference therebetween. To maintain the high-frequency transmission performance of PCIe, existing technologies typically address signal interference by improving the positioning of different pairs of differential signal terminals. For example, the differential signal terminals are arranged according to their pair count (i.e., arranging different pairs at different locations) to increase spacing, or placing multiple ground terminals between different pairs of differential signal terminals.

However, limited by channel configuration, to ensure transmission efficiency, the distance between some different pairs of differential signal terminals may still result in interference. In other words, the aforementioned existing techniques have not effectively reduced signal interference between different pairs of differential signal terminals.

Therefore, the present disclosure provides a connector that can effectively reduce signal interference between different pairs of differential signal terminals and improve the stability of high-frequency signal transmission. Some embodiments will be described below with reference to the accompanying drawings. Unless otherwise specified, the following embodiments and features can be combined with each other.

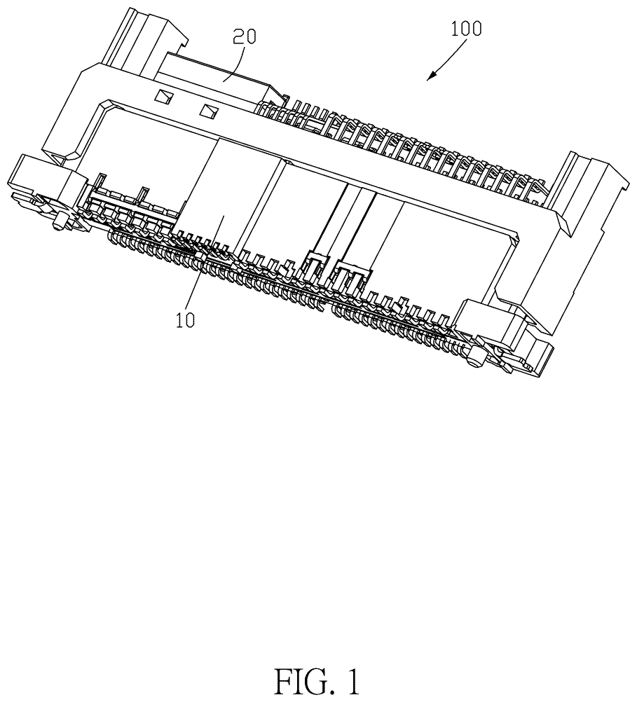

Referring to FIG. 1, the present disclosure provides a connector assembly 100, including a receptacle connector/electrical connector 10 and a plug connector/mating connector 20. The plug connector 20 can be inserted into the receptacle connector 10. The receptacle connector 10 can be arranged on or electrically connected to a computer motherboard, and the plug connector 20 can be arranged on or electrically connected to a peripheral device.

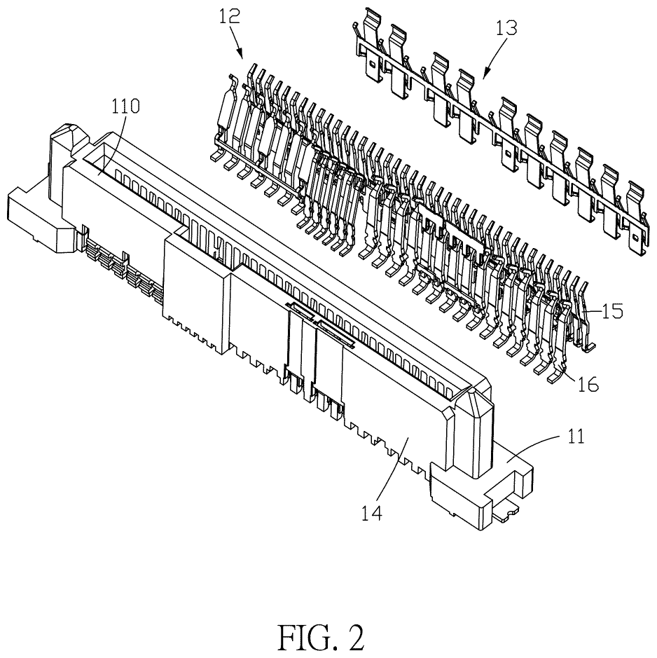

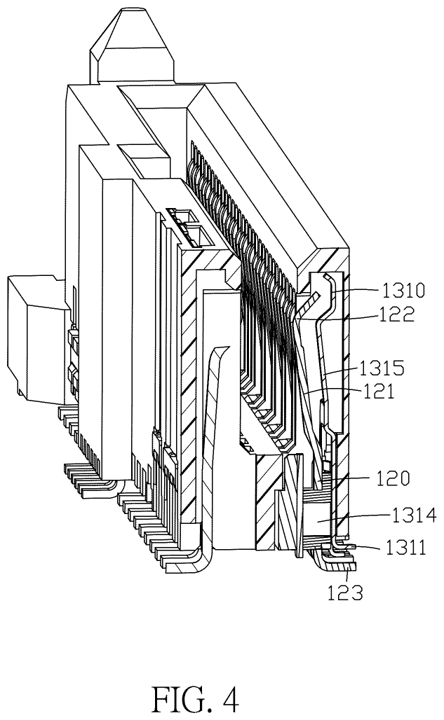

Referring to FIG. 2, in some embodiments of the present disclosure, the receptacle connector 10 may include an insulating body 11, terminals 12, and a first grounding member 13. The insulating body 11 includes a slot 110 passing through the upper face of the insulating body 11, and sidewalls 14 arranged at two sides of the slot. The terminals 12 include a row of first terminals 15 arranged at one side of the slot 110, and a row of second terminals 16 arranged at the other side of the slot 110. Referring to FIG. 4, each of the terminals 12 includes a fixing portion 120 embedded in the insulating body 11, a resilient portion 121 extending upward from the fixing portion 120, a contact portion 122 located at an end of the resilient portion 121 and protruding into the slot 110, and a leg portion 123 extending downward from the fixing portion 120 out of the lower face of the insulating body 11. Each of the two side walls 14 has a plurality of terminal slots, and the terminals 12 are respectively arranged in the terminal slots. To ensure the resilience of the resilient portion 121, the resilient portion 121 extends upward into and inclines toward the slot 110 in the terminal slot.

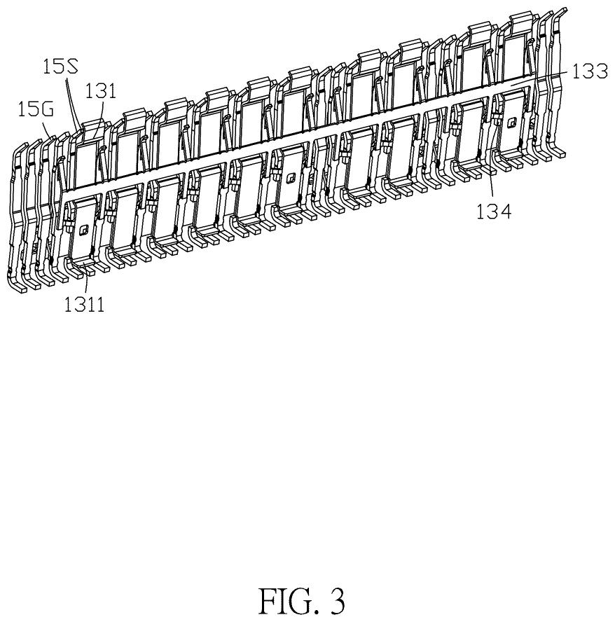

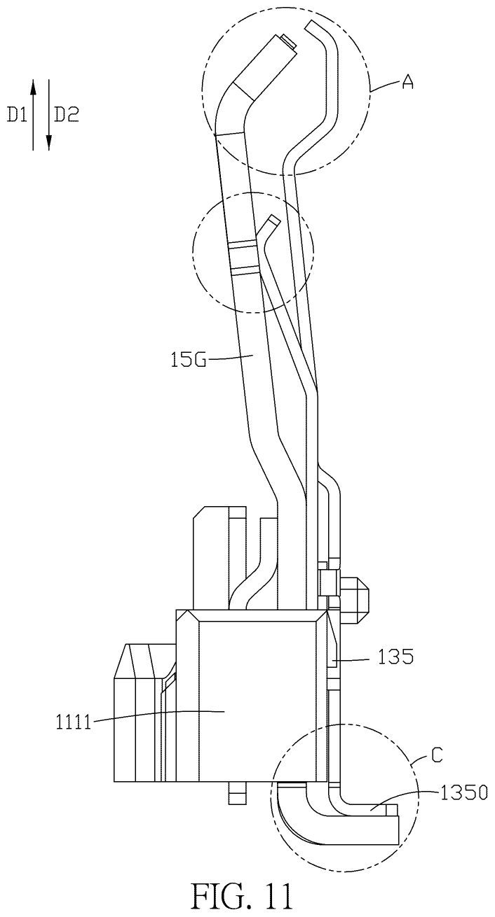

Referring to FIGS. 3-5, the first terminals 15 includes several pairs of first signal terminal pairs 15S and first ground terminals 15G each arranged between two neighboring first signal terminal pairs 15S. The first grounding member 13 is arranged at an outer side of the first terminals 15 distal from the second terminals 16. The first grounding member 13 includes first shielding portions 131 extending in the vertical direction and shielding the outer side of the first signal terminal pairs 15S, and grounding portions 132 arranged on an outer side of the first ground terminals 15G and respectively contacting the first ground terminals 15G. Each of the first shielding portions 131 extends upward and exceeds the height of the corresponding first signal terminal pair 15S, and the first shielding portion 131 protrudes outward near the corresponding contact portion 122 to form an outward protrusion 1310 to provide space for the deformation of the contact portion 122. The leg portion 123 extends downward from the insulating body 11 and bends outward, and the first shielding portion 131 extends downward from the insulating body 11 and bends outward to form a bent leg portion 1311, which shields the upper part of the corresponding leg portion 123. Referring again to FIG. 4, or specifically to portion A in FIG. 11, the first shielding portion 131 includes a fixture portion 1314 fixed in the insulating body and parallel to the fixing portion, and an inclined portion 1315 inclined upward from the fixture portion 1314 and parallel to the resilient portion. An outwardly protruding portion 1310 protrudes outward from the upper end of the inclined portion 1315, and the free end of the contact portion 122 is positioned in the cavity formed by the corresponding outwardly protruding portion 1310.

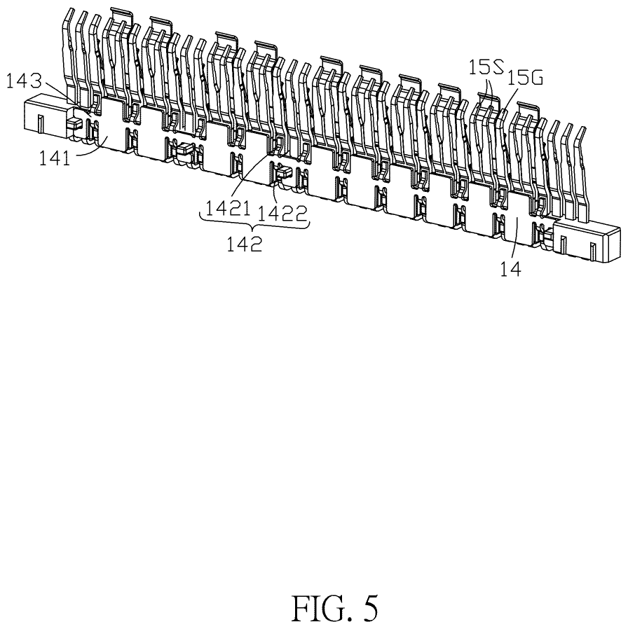

Referring again to FIGS. 2-4, the first grounding member 13 includes a ridge 133 extending longitudinally to connect the grounding portions (not shown) and the first shielding portions 131. The grounding portions includes first grounding portions 132, which are inclined upward and can contact the resilient portion 121 of the corresponding first ground terminal 15G. In the present embodiment, the first grounding portion 132 can contact and abut the resilient portion 121 of the corresponding first ground terminal 15G when the plug connector 20 is not inserted into the slot, and can also not abut when the plug connector 20 is not inserted into the slot 110. However, after the plug connector 20 is inserted into the slot 110, the resilient portion 121 of the first ground terminal 15G expands outward and abuts the corresponding first grounding portion 132. The first grounding member 13 also includes a lower connecting portion 134 extending downward from the ridge 133. The lower connecting portion 134 is connected to the shielding portions 131 on the left and right sides to enhance the strength of the first grounding member 13. Referring to FIG. 5, in order to enable the electrical connector 10 to have better high-frequency performance, the electrical connector 10 also includes a second grounding member 14 located inside the first terminals 15. Namely, the second grounding member 14 is located on the side of the first terminal 15 proximal to the second terminals 16, and has a structure that is roughly the same as the first grounding member 13. The second grounding member 14 includes a second shielding portion 141 that shields the inside of the first signal terminal pairs 15S, grounding portions 142 positioned inside the first ground terminals 15G and contacting the first ground terminals 15, and a longitudinal ridge 143 connecting the second shielding portions 141 and the grounding portions 142. Each of the grounding portions 142 includes a third grounding portion 1421 extending upward from the ridge 143 and a fourth grounding portion 1422 extending downward from the ridge 143. The third grounding portion 1421 is in contact with the upper end of the corresponding fixing portion 120, and the fourth grounding portion 1422 is in contact with the lower end of the corresponding fixing portion 120.

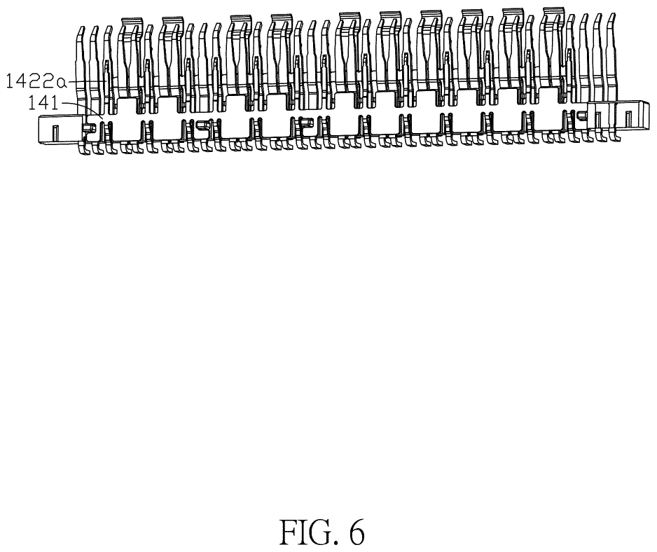

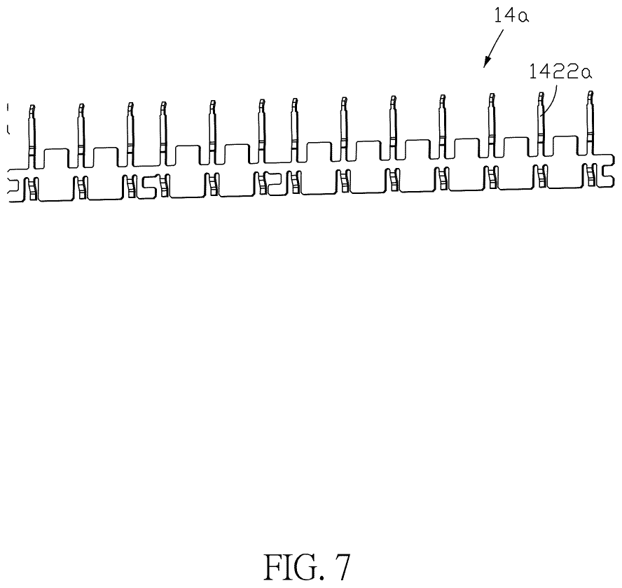

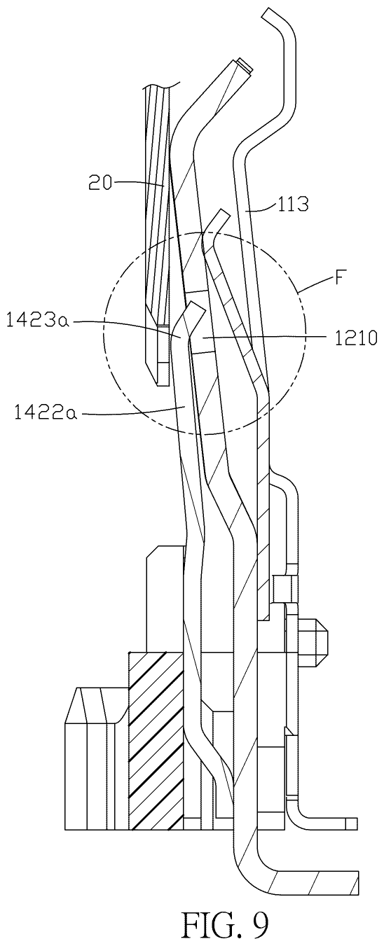

FIGS. 6-9 are partial perspective views of the electrical connector 10 in the second embodiment of the present disclosure. The second grounding member 14a has a structure which is basically the same as the second grounding member 14 in the above embodiments. The following mainly describes the differences therebetween; the identical parts will not be repeated, and the identical parts will use the same names and reference numerals. Unlike the first embodiment, in the present embodiment, the resilient portion 121 of the first ground terminal 15G has a receiving slot 1210, and the fourth grounding portion 1422a extends upward from the ridge 143 with its free end extending into the receiving slot 1210. Additionally, the fourth grounding portion 1422a has a mating contact portion 1423a protruding into the slot 110. Thus, when the plug connector 20 is inserted into the socket connector/electrical connector 10, the corresponding ground terminal of the plug connector 20 makes electrical contact with the mating contact portion 1423a, as detailed at portion F in FIG. 9.

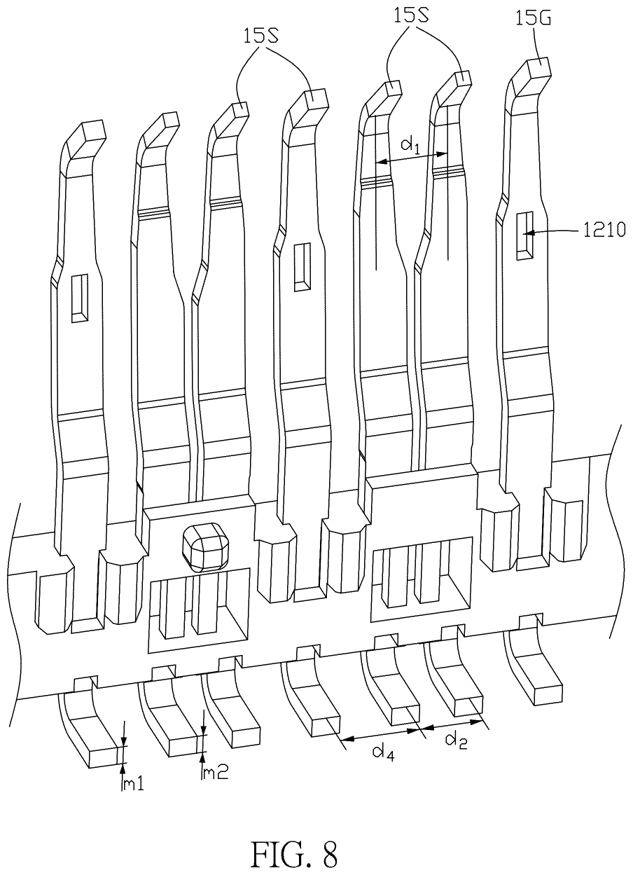

Referring to FIG. 8, in the present disclosure, the width of each first signal terminal 15S gradually narrows from the upper end of the resilient portion 121 near the contact portion 122 to the end of the contact portion 122. The distance between a pair of first signal terminals 15S at the upper end of the resilient portion 122 is d1, and d1 is preferably 0.8 mm. The distance between a pair of first signal terminals 15S at the leg portion 123 is d2, where d2 is less than d1, and d2 is preferably 0.68 mm. Furthermore, the distance between a first signal terminal 15S and an adjacent ground terminal 15G at the upper end of the resilient portion 122 is d3, and the distance between a first signal terminal 15S and an adjacent ground terminal 15G at the leg portion 123 is d4, where d3 is greater than d1, and d4 is greater than d2. The thickness of the first ground terminal 15G is m1, preferably 0.2 mm to 0.25 mm. The thickness of the first signal terminal 15S is m2, where m1 is greater than m2.

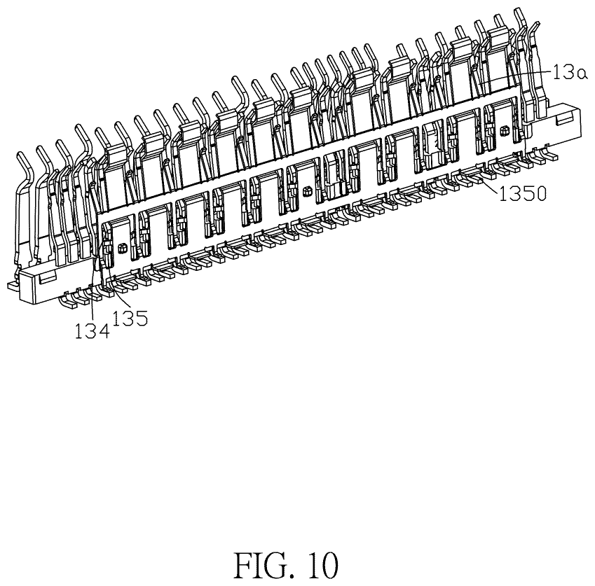

FIGS. 10-11 are perspective views of the socket connector/electrical connector 10 in the third embodiment of the present disclosure. The first grounding member 13a has basically the same structure as the grounding member 13 in the first embodiment. The following mainly describes the differences therebetween; the identical parts will not be repeated, and the identical parts will use the same names and reference numerals. In the present embodiment, the grounding member 13a also includes a second grounding portion 135. The second grounding portion 135 extends downward from the lower connecting portion 134 and bends outward. Therefore, the second grounding portion 135 can also be considered as extending downward from the ridge portion 133 and bending outward. Referring to portion C of FIG. 11, the second grounding portion 135 bends outward at its lower end to form a contact leg portion 1350, and the contact leg portion 1350 abuts downward against the top of the leg portion 123 of the corresponding first ground terminal 15G.

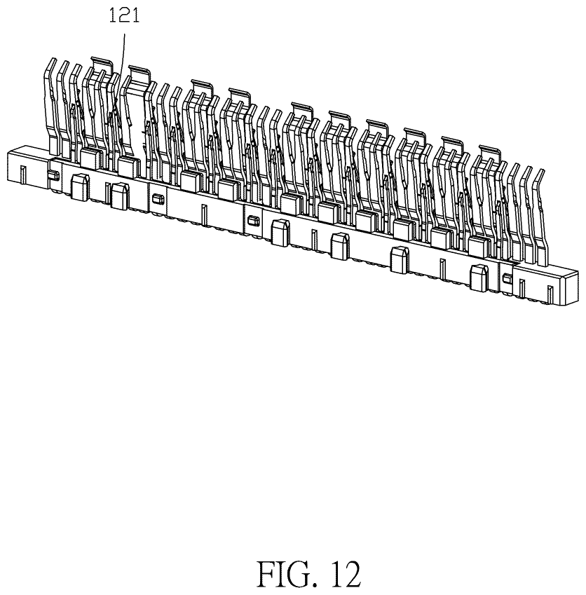

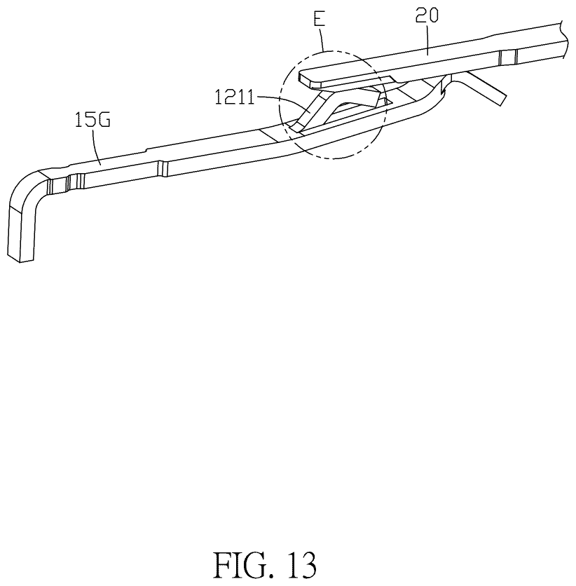

FIGS. 12-13 are partial schematic diagrams of the socket connector/electrical connector 10 in the fourth embodiment of the present disclosure. In the present embodiment, the inner side of the electrical connector 10 is no longer provided with a second grounding member. To ensure that the plug connector 20 has more contact points with the socket connector 10 when inserted, namely to allow the corresponding ground terminal of the plug connector 20 to have better contact with the first ground terminal 15G of the socket connector 10, the first ground terminal 15G has a protruding abutment portion 1211 at its resilient portion 121 protruding into the slot 110. Thus, when the plug connector is inserted, the corresponding ground terminal of the plug connector 20 can simultaneously contact the contact portion 122a and the abutment portion 1211 of the first ground terminal 15G of the socket connector 10, as detailed at portion E in FIG. 13 below.

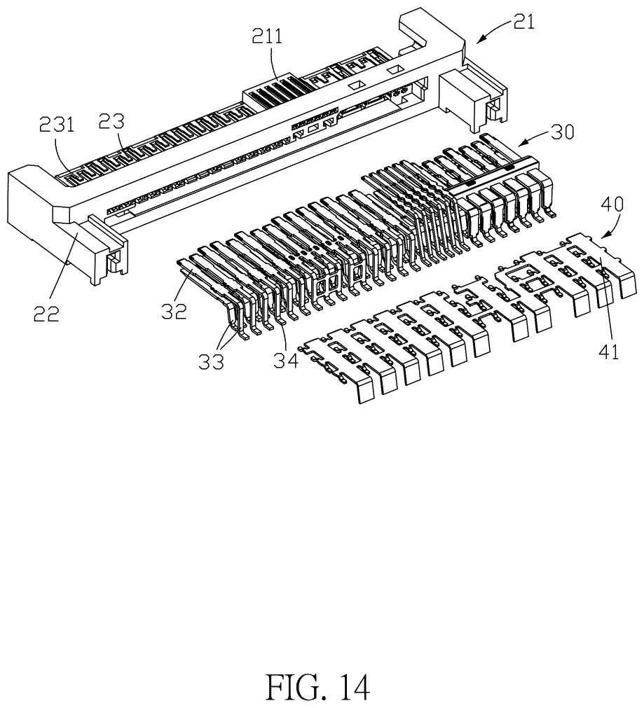

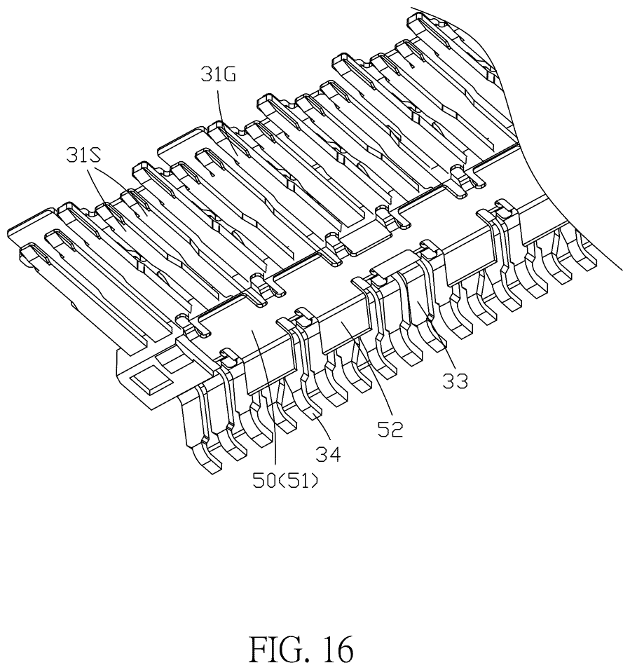

FIGS. 14-17 are schematic diagrams of the fifth embodiment of the present disclosure. The plug connector 20 includes an insulator 21, terminals/mating terminals 30 arranged on the insulator 21, and a third grounding member 40. The insulator 21 includes a base 22 and a tongue 23 extending forward from the base 22. The tongue 23 includes an upper face 231 having a protrusion 211 and a lower face (not shown) opposite to the upper face 231. The mating terminals 30 include a row of third terminals 31 positioned on the lower face of the tongue 23 and a row of fourth terminals 32 positioned on the upper face of the tongue 23. The third grounding member 40 is positioned above the third terminals 31 and between the rows of third terminals 31 and the rows of fourth terminals 32 in the vertical direction. The third terminals 31 include a plurality of pairs of third signal terminal pairs 31S and a third ground terminal 31G positioned between two neighboring third signal terminal pairs 31S. Each mating terminal 30 includes a fixing portion (not shown) fixed to the insulator 21, a mating portion 322 extending forward from the fixing portion and exposed at the face of the tongue plate 23, a first lower extension portion 33 extending downward from the fixing portion, and a horizontal portion 34 bending in the horizontal direction from the first lower extension portion 33. The third grounding member 40 is positioned between the third terminal 31 and the fourth terminal 32, and includes a third shielding portion 41 shielding the third signal terminal pair 31S. The third shielding portion 41 includes a second lower extension portion 42 positioned on the side of the first lower extension portion 33 near the fourth terminal 32 and facing the first lower extension portion 33, so as to shield the first lower extension portion 33 through the second lower extension portion 42. The plug connector 20 also includes a fourth grounding member 50 positioned below the third terminal 31. The fourth grounding member 50 includes a fourth shielding portion 51 that shields the third signal terminal pair 31S. The fourth shielding portion 51 includes a third lower extension portion 52 positioned on the other side of the first lower extension portion 33 and facing the first lower extension portion 33, so as to shield the other side of the first lower extension portion 33 of the third terminal.

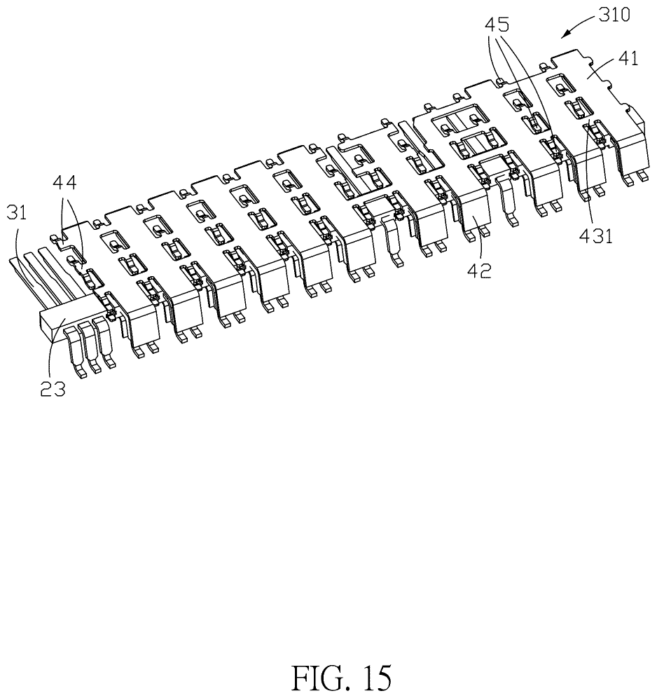

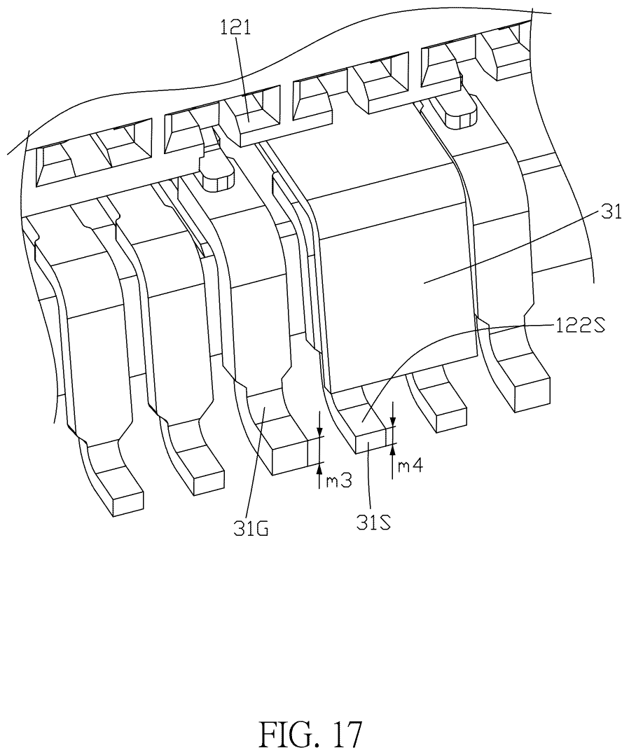

Referring to FIG. 15, in the present embodiment, the third grounding member 40 includes a ridge extending longitudinally and connecting a plurality of third shielding portions 41. The ridge includes a main ridge 431 and two secondary ridges 432. The third terminal 31 is held in place by an insulating strip 63 to form an integral third terminal module 310. The main ridge 431 overlaps the insulating strip 63. One secondary ridge 44 is disposed near the free end of the mating portion 322 of the mating terminal 30, and the other secondary ridge 432 is disposed near the middle of the mating portion 322 in the front-back direction. The third grounding member 40 also includes a plurality of grounding fingers 45 extending from two sides of the main ridge 43 and the secondary ridge 44. The fourth grounding member 50 includes a ridge 53 connecting the fourth shielding portion 51. The ridge 53 overlaps the other side of the insulating strip 23, and in the present embodiment, the fourth grounding member 50 is arranged adjacent to the fixing portion 31 of the mating terminal 30. Referring to FIG. 17, in the present embodiment, the thickness of the third ground terminal 31G is m3, preferably between 0.2 mm and 0.3 mm, and the thickness of the third signal terminal 31S is m4, where m4 is less than m3.

Finally, it should be noted that the above embodiments are only used to illustrate the technical solutions of the present disclosure and are not intended to limit it. Although the present disclosure has been described in detail with reference to preferred embodiments, those skilled in the art should understand that modifications or equivalent substitutions can be made to the technical solutions of the present disclosure without departing from the spirit and scope of the technical solutions of the present disclosure.

1. An electrical connector comprising:
an elongated insulating body;
a plurality of terminals; and
a first grounding member; wherein
the insulating body has a slot passing through an upper face thereof and sidewalls on two sides of the slot, the terminals comprise a row of first terminals at one side of the slot and a row of second terminals at the other side of the slot, each of the terminals includes a fixing portion embedded in the insulating body, a resilient portion extending upward from the fixing portion, a contact portion positioned at an end of the resilient portion and protruding into the slot, and a leg portion extending downward from the fixing portion out of a lower face of the insulating body, the first terminals comprise a plurality of first signal terminal pairs and first ground terminals positioned between neighboring first signal terminal pairs, the first grounding members are arranged on an outer side of the first terminals distal from the second terminals and each have a first shielding portion extending vertically and shielding outer sides of the first signal terminal pairs and a grounding portion positioned outside the first ground terminal and capable of contacting the corresponding first ground terminal, and the first shielding portion extends upward beyond a height of the corresponding first signal terminal pair and protrudes outward near the contact portion to form an outward protrusion to provide space for the contact portion.

2. The electrical connector according to claim 1, wherein the leg portion is bent outward below the lower face, the first shielding portion extends downward from the insulating body and bends outward to form a bent leg portion, and the bent leg portion shields the upper portion of a corresponding leg portion.

3. The electrical connector according to claim 2, wherein the first grounding member includes a ridge extending longitudinally to connect the grounding portion and the first shielding portion, the grounding portion has a first grounding portion and a second grounding portion, the first grounding portion tilts upward from the ridge and contacts a resilient portion capable of contacting a corresponding first ground terminal, the second grounding portion extends downward from the ridge and bends outward at its end to form a bent portion, and the bent portion contacts the leg portion of the corresponding first ground terminal.

4. The electrical connector according to claim 1, wherein the electrical connector further has a second grounding member positioned on an inner side of the first terminals near the second terminals, each of the second grounding members has a ridge and a third grounding portion extending downward from the ridge and towards the fixing portion of the corresponding first ground terminal, and the third grounding portion contacts the corresponding fixing portion.

5. The electrical connector according to claim 1, further comprising a second grounding member, wherein the second grounding member is positioned inside the first terminals near the second terminals, the second grounding member has a ridge and fourth grounding portions extending upward from the ridge and toward the resilient portions of the first ground terminals, each of the resilient portions of the first ground terminals has a receiving slot, and the free ends of the fourth grounding portions extend respectively into the receiving slots.

6. The electrical connector according to claim 1, wherein a distance between a pair of first signal terminals near the contact portion is d1, and a distance between the leg portions of the pair of first signal terminals is d2, and d1 is greater than d2.

7. The electrical connector according to claim 6, wherein a distance between one of the first signal terminals and an adjacent first ground terminal near the contact portion is d3, and a distance between the first signal terminal and the adjacent first ground terminal near the leg portion is d4, d1 is less than d3, and d2 is less than d4.

8. The electrical connector according to claim 1, wherein a thickness of the first ground terminal is m1, and m1 is between 0.2 mm and 0.25 mm.

9. The electrical connector according to claim 1, wherein the resilient portion of the first ground terminal has an abutment portion protruding into the slot.

10. The electrical connector according to claim 1, wherein the first shielding portion includes a fixture portion fixed in the insulating body and an inclined portion inclining upward from the fixture portion, the outward protrusion protrudes outward from the upper end of the inclined portion, and the free end of the contact portion is positioned in a cavity of the outward protrusion.

11. An electrical connector comprising:
an insulator;
a plurality of mating terminals; and
a third grounding member; wherein
the insulator has a base and a tongue extending forward from the base, the mating terminals include a row of third terminals arranged on the lower side of the tongue and a row of fourth terminals arranged on the upper side of the tongue, the third terminals have a plurality of third signal terminal pairs and third ground terminals positioned between adjacent third signal terminal pairs, each of the mating terminals has a fixing portion fixed in the base and a mating portion extending forward from the base and exposed on the side of the tongue, a first lower extension portion bent downward from the fixing portion, and a horizontal portion bent horizontally from the lower extension, the third grounding member is positioned between the third terminals and the fourth terminals and has second shielding portions shielding the third signal terminal pairs, and each of the second shielding portions has a second lower extension portion positioned on a first side of the first lower extension portion and facing the first lower extension portion to shield the first lower extension portion on one side.

12. The electrical connector according to claim 11, wherein the electrical connector includes a fourth grounding member positioned below the third terminal, the fourth grounding member has a fourth shielding portion shielding the area below the third signal terminal pair, the fourth shielding portion has a third lower extension portion positioned on the other side of the first lower extension portion and arranged facing the first lower extension portion, so as to shield the first lower extension portion on the other side.

13. The electrical connector according to claim 11, wherein a thickness of the third ground terminal is m2, and m2 is between 0.2 mm and 0.3 mm.

14. The electrical connector according to claim 13, wherein a thickness of the third signal terminal of the third signal terminal pair is m3, and m2 is greater than m3.
